(19) United States
(12) Patent Application Publication
(10) Pub. No.: US 2012/0015574 A1
(43) Pub. Date: Jan. 19, 2012

(54) METHOD FOR FORMULATING A REACTIVE POLYURETHANE EMULSION

(75) Inventors: Birgit Severich, Mannheim (DE); Thomas Schauber, Hemsbach (DE); Horst Muehlfeld, Grasellenbach (DE); Robert Groten, Sundhoffen (FR); Bjoern Hellbach, Weinheim (DE); Ansgar Komp, Heidelberg (DE); Christian Waschinski, Heidelberg (DE)

(73) Assignee: CARL FREUDENBERG KG, Weinheim (DE)

(21) Appl. No.: 13/258,515

(22) PCT Filed: Mar. 25, 2010
(86) PCT No.: PCT/EP2010/001863

§ 371 Date: Sep. 22, 2011

(30) Foreign Application Priority Data
Mar. 27, 2009 (DE) 10 2009 014 699.7

(51) Int. Cl. B32B 27/04; C08K 5/51; B05D 3/10; C09D 5/14; C09D 163/00; B05D 3/02; C09D 175/04; C08K 5/52

(52) U.S. Cl. 442/79; 524/590; 524/136; 524/140; 524/141; 523/122; 523/451; 427/389.9; 427/381; 442/93; 442/123; 442/136; 442/118

(57) ABSTRACT

A method for production of a reactive polyurethane emulsion for use in impregnating and coating a textile fabric includes reacting polyols alone or in combination with at least one of diols and triols with a substoichiometric amount of diisocyanates so as to form medium-viscosity, OH-terminated prepolymers. The prepolymers are mixed with an external emulsifier. At least one of a diisocyanate, a triisocyanate and a polyisocyanate are added so as to bring about a crosslinking of the prepolymers.

### CROSS REFERENCE TO PRIOR APPLICATIONS

This application is a U.S. National Phase Application under 35 U.S.C. §371 of International Application No. PCT/EP2010/001863, filed on Mar. 25, 2010 and claiming benefit to German Patent Application No. DE 10 2009 014 699.7, filed on Mar. 27, 2009. The International Application was published on Sep. 30, 2010 as WO 2010/108676 under PCT Article 21 (2).

### FIELD

The present invention relates to a method for the production of a reactive polyurethane emulsion.

### BACKGROUND

Methods for the production of polyurethane dispersions are described, for example, in world patent application WO 02/08327 A1, U.S. Pat. No. 6,017,997 A, world patent application WO 01/27179 A1, German patent specification DE 29 31 125 C2 and European patent application EP 0 962 585 A2 and are normally carried out in the following stages:

A polyol, another diol, for instance, dimethylol propionic acid, and a diisocyanate are reacted. The reaction yields a prepolymer having acid groups and terminal isocyanate functions. The isocyanate-terminated prepolymer is dispersed in water by means of the incorporated acid groups and subsequently reacted with amine and/or water for purposes of chain lengthening. Due to the relatively high viscosity of the prepolymer, its dispersion in water requires an organic solvent that lowers the viscosity to such an extent that it can be dispersed well. N-methyl-2-pyrrolidone is a frequently employed solvent, so that the commercially available polyurethane dispersions with a solids content of approximately 35% by weight still have a solvent content of about 5% by weight. Sometimes, acetone is also employed as the solvent, most of which can be removed later on by means of distillation. Residues of it, however, always remain in the dispersion.

In polyurethane chemistry, it is a practice to add special additives in order to modify the properties of materials. In the realm of textile impregnations and textile coatings, the flame-retardant, antimicrobial, dirt-repellant and hydrophilic properties are of special interest.

The flame-retardant finishing of polyurethanes is often employed for foams or compact materials. Here, mainly additives on the basis of flame retardants that are mineral-based or that contain halogen, phosphorus or nitrogen as well as intumescence systems are used. For instance, German patent application DE 1812165 A describes the production of flame-retardant polyurethane foams by admixing phosphorus or halogen compounds.

In contrast, the antimicrobial finishing of polyurethanes is often achieved by adding silver ions. U.S. First Published Patent Application 2007/0092556 A1 describes a polyurethane resin that acquires an antimicrobial effect due to the addition of silver ions and that is suitable for applying a very thin polyurethane layer onto textiles.

Regarding the optimization of the dirt-repellant properties, U.S. Pat. No. 3,968,066 describes a textile impregnation whose hydrophobia was enhanced by the addition of fluorocarbons.

In comparison to hydrophobic polyurethane prepolymers, hydrophilic variants, in contrast, generally entail the advantage that they are considerably easier to emulsify. The literature even describes cases of highly hydrophilic prepolymers that are spontaneously converted into emulsions when they are mixed with water (Kunststoff Handbuch 7, Polyurethane [Plastics Manual, Polyurethanes 7], by Oertel G., published by Carl Hanser Verlag, Munich, Germany and Vienna, Austria, 30-31). Another advantage of emulsions that were made out of hydrophilic prepolymers is their markedly longer storage stability in comparison to hydrophobic systems. Thus, ionic groups are incorporated into the polymer by means of chain extenders during an ionic stabilization procedure. In this context, German document DE 2035732, for instance, discloses diamino sulfonic acid salts and their use as an anionic synthesis component in the production of polyurethane dispersions that are free of emulsifiers.

### SUMMARY OF THE INVENTION

In an embodiment, the present invention provides a method for production of a reactive polyurethane emulsion for use in impregnating and coating a textile fabric. Polyols alone or in combination with at least one of diols and triols are reacted with a substoichiometric amount of diisocyanates so as to form medium-viscosity, OH-terminated prepolymers. The prepolymers are mixed with an external emulsifier. At least one of a diisocyanate, a triisocyanate and a polyisocyanate are added so as to bring about a crosslinking of the prepolymers.

### DETAILED DESCRIPTION

In an embodiment, an aspect of the present invention includes a method for the production of reactive polyurethane emulsions or of soft polyurethanes that can be readily dispersed in water, preferably without an organic solvent, and that are particularly well-suited for a cost-efficient and, to the greatest extent possible, environmentally sound impregnation and/or coating of textile fabrics.

The term impregnation and/or coating as used here refers especially to the impregnation or soaking through of the entire textile and to the coating of the individual fibers. This yields a very uniform finish that is relatively economical in terms of the amount that has to be applied.

Moreover, according to an embodiment of the method, it is possible to produce highly lightfast and very soft textile fabrics with a leather-like hand, all of which, up until now, can only be achieved through the formation of a poromeric structure by means of the coagulation of solutions.

Furthermore, an embodiment of the method should also be particularly well-suited for the addition of flame retardants, antimicrobial agents or biocides, hydrophilic agents or stain-resistant agents, or else to achieve a wash-resistant and permanently flame-retardant, antimicrobial, hydrophilic or dirt-repellant finish.

According to an embodiment of the present invention, the method for the production of a reactive polyurethane emulsion to impregnate and/or coat textile fabrics is carried out in such a way that medium-viscosity, OH-terminated prepolymers are produced by reacting polyols with a substoichiometric amount of diisocyanates, or else by reacting polyols in combination with diols and/or triols with a substoichiometric amount of diisocyanates, after which the prepolymers are mixed with an external emulsifier, and then a diisocyanate, triisocyanate and/or polyisocyanate is added to bring about the later crosslinking of the OH-terminated prepolymers.

In an embodiment, it is also possible to produce particularly soft textile fabrics with a leather-like hand that ensure good wearing and handling comfort, especially with an eye towards their use in textiles in the technical, medical, civil or military realms, particularly in upholstery, linings, fabrics for furniture covers, mattress covers and bed covers, curtains, blinds, wallpaper, tents, geotextiles, hygiene and cleaning articles or else in functional clothing such as uniforms or protective garments.

In a specific embodiment of the method, a method for providing textile fabrics with a flame-retardant finish is to be put forward which allows a highly cost-efficient and environmentally sound, uniformly distributed, highly wash-resistant and permanently flame-retardant impregnation and/or coating of a wide array of textile fabrics.

Preferably, in an embodiment, the method for the production of a reactive polyurethane emulsion to create a flame-retardant impregnation and/or coating of textile fabrics is carried out in such a manner that medium-viscosity, OH-terminated prepolymers are produced by reacting the polyols with a substoichiometric amount of diisocyanates in the presence of OH- or NH₂-difunctionalized or OH- or NH₂-polyfunctionalized flame retardants, or else by reacting the polyols with a substoichiometric amount of diisocyanates in combination with diols and/or triols as well as with OH- or NH₂-difunctionalized or OH- or NH₂-polyfunctionalized flame retardants, after which the prepolymers are mixed with an external emulsifier, and then a diisocyanate, triisocyanate and/or polyisocyanate is added to bring about the later crosslinking of the OH-terminated prepolymers.

In this context, the OH- or NH₂-difunctionalized or OH- or NH₂-polyfunctionalized flame retardants react with the diisocyanates via an addition reaction analogously to the polyols that have been used, and are thus covalently incorporated into the prepolymer chain that is being formed.

Subsequently, the prepolymers that have been formed are mixed with an external emulsifier and advantageously dispersed in water, thus forming low-viscosity emulsions with which textile fabrics can be impregnated extremely well.

Subsequently, the textile fabric that has been impregnated and/or coated with the reactive polyurethane emulsion is dried, preferably by heating, in order to crosslink the OH-terminated prepolymer.

The application in the form of this polyurethane emulsion entails the advantage of a uniform distribution of the flame retardant on the surface of the fibers of the textiles.

The chemical incorporation of the flame-retardant additives into the polymer matrix provides the fibers of the thus finished textiles with permanent and wash-proof flame-retardant protection.

Applicants have discovered that the crystallization of the obtained polyurethanes is disrupted by the incorporation of OH- or NH₂-difunctionalized or OH- or NH₂-polyfunctionalized flame retardants, thus resulting in very soft impregnations or coatings, especially without a need to add other additives such as, for instance, OH-functionalized polysiloxanes.

Examples of suitable flame-retardant additives or flame-retardant agents are all molecules that have flame-retardant properties and that carry at least two reactive hydroxyl or amino groups at each of their two ends or in the side chains.

Preferably, in an embodiment, the following are employed as OH- or NH₂-difunctionalized or OH- or NH₂-polyfunctionalized flame retardants:

OH- or NH₂-di-terminated or OH- or NH₂-tri-terminated phosphinoxides, especially those having the general molecular formula [P(O)(—R¹)(—R²—OH)(—R³—OH)] wherein R¹ stands for H, branched or unbranched alkyl radicals having 1 to 12 carbon atoms, substituted or unsubstituted aryl radicals having 6 to 20 carbon atoms, substituted or unsubstituted aralkyl radicals having 6 to 30 carbon atoms, or substituted or unsubstituted alkaryl radicals having 6 to 30 carbon atoms, and R², R³ stand for branched or unbranched alkylene radicals having 1 to 24 carbon atoms, or substituted or unsubstituted alkarylene radicals having 6 to 30 carbon atoms, wherein R² and R³ can be the same or different.

Preference is likewise given to the use of OH- or NH₂-difunctionalized or OH- or NH₂-polyfunctionalized flame retardants:

OH- or NH₂-di-terminated or OH- or NH₂-tri-terminated phosphatoligomers, especially those having the general molecular formula [P(O)(—OR¹)₂—O—R²—O]ₙ—P(O)(OR¹)₂ wherein n=2 to 20, preferably 2 to 10,

R¹ stands for branched or unbranched hydroxyalkyl radicals having 2 to 10 carbon atoms;
R² stands for alkylene group having 2 to 10 carbon atoms, or

OH- or NH₂-di-terminated or OH- or NH₂-tri-terminated triarylphosphates,

OH- or NH₂-di-terminated diarylalkyl phosphates, or

reactive P(III)-phosphorus polyols, especially those having the general molecular formula HO—R¹—O—[P(O)(R²)—O—R³—O-]P(O)(R²)—O—R¹—OH such as, for example, Exolit OP 560 (made by the Clariant company).

The list above contains only a few typical examples and does not cover all possible OH-terminated or NH₂-terminated flame retardants.

In summary, flame retardants containing phosphorus function in such a way that, on the one hand, a solid surface layer including polyphosphonic acid forms on the material due to endothermic condensation, and this surface layer itself already constitutes a barrier against oxygen and heat. On the other hand, this polyphosphonic acid catalyzes the elimination of functional groups of the polymer all the way to carbonization. The carbon layer that is formed in this process shields the polymer in terms of material and energy from the source of fire and prevents dripping of the burning, melted polymer.

Advantageously, the OH- or NH₂-difunctionalized or OH- or NH₂-polyfunctionalized additives or flame retardants are employed in an amount ranging from 10% to 50% by weight, preferably from 15% to 35% by weight, relative to the total weight of the textile.

Below a value of 10% by weight, impregnation with the flame retardant does not display a very good flame-retardant effect. Above 10% by weight, the desired flame-retardant effect is achieved while, at the same time, the impregnated textile exhibits a soft and velvety hand. Above 35% by weight, the textile remains soft due to the increased amount of impregnation but it then tends to feel more like rubber or silicone.

Laundering experiments were carried out in which nonwovens on the basis of Evolon® (microfiber textile consisting of a polyester-polyamide blend made by the Freudenberg company) that had been impregnated with polyurethane emulsions underwent ten laundering cycles at temperatures of 40° C., 60° C. and 90° C. [104° F., 140° F. and 194° F.]. No removal of the coating from the fibers was observed in this process.

The drawbacks of commercially available fiber materials with flame retardants such as, for example, migration or washing-out of the flame retardants as well as the associated harm to the environment are, in fact, prevented by the specific embodiment presented here.

Flame-retardant melt additives described in the state of the art are added, for example, during the production of textile fibers or of the fiber material from the melt, as a result of which they yield a uniform distribution of the flame retardant in the form of particles within the entire fiber material in question. However, they are not incorporated covalently. A drawback of this method is also that larger amounts of the usually expensive flame retardant chemicals are needed since they are not concentrated on the surface because of the uniform distribution, but rather, are also present inside the polymers, where they have less of an effect.

The flame retardants have to be temperature-stable so that they can withstand the usually high melt temperatures over a prolonged period of time without degrading. Moreover, dripping of the polymer in case of fire is not prevented by flame-retardant melt additives. In fact, when the melting temperature is reached, the polymers soften and subsequently drip. The uniformly distributed flame retardant cannot achieve a sufficiently insulating or cooling effect to prevent this from happening.

The melt additives described in the state of the art also have to be optimally harmonized with the polymers in question in order to prevent their migration out of the polymers over the course of time, which would then cause a deterioration of the fire properties of the fibers.

Fewer changes in the material properties occur when the flame retardants are incorporated as co-monomers into the spinning polymers. This, however, also calls for the use of equally large amounts as in the case of the flame-retardant melt additives. Furthermore, these flame-retardant polymers are very expensive and dripping in case of fire is not prevented with these materials either. Fibers in this context are Trevira CS (aliphatic, carboxyl-functionalized phosphinate in an amount of 3% to 20% by weight of the acid component condensed into the main chain, made by the Trevira GmbH company or by Hoechst AG, see, for instance, German patent application DE 3940713 A) as well as the fibers Ulkanol ES-PET (aromatic phosphinate in the side chain containing 12.2% by weight of phosphorus, made by the Schill and Seilacher company, see, for instance, German laid-open document DE 10330774 A1).

Nonwovens can also have flame-retardant properties through the use of inherently flame-retardant fibers such as, for example, aramid fibers, glass fibers or melamine fibers. The disadvantage here, however, is, on the one hand, the high price of the fibers and, on the other hand, the usually insufficient textile properties of the fibers employed in terms of their wearing comfort. Glass fibers are, for instance, scratchy and irritate the skin.

The application of a flame retardant in the form of a coating is much more cost-effective than the three above-mentioned finishing methods. The flame retardant of the present invention is located only on the surface of the textile and consequently functions only where it is needed. The application of a coating means that flame-retardant additives can be selected with considerably more freedom since they can also be present in particulate form and do not have to withstand continuously high melting and spinning temperatures, which could lead to a premature degradation of the additives. Moreover, it is possible to apply a single coating onto various textiles, which renders the use considerably more flexible.

In contrast, the uniform distribution of the flame retardant on the fiber surface as well as the wash resistance of the coating pose a challenge that is overcome by the present preferred embodiment according to the invention.

In a preferred alternative or cumulative embodiment of the method for the production of a reactive polyurethane emulsion or of soft polyurethanes, and also especially for the flame-retardant impregnation and/or coating of textile fabrics, a method for the antimicrobial finishing of textile fabrics is to be put forward with which it is possible to obtain a particularly cost-efficient and environmentally sound, uniformly distributed, highly wash-resistant and permanent antimicrobial impregnation and/or coating of a wide array of textile fabrics.

Advantageously, the method for the production of a reactive polyurethane emulsion for the antimicrobial impregnation and/or coating of textile fabrics is carried out in two different ways.

In a first embodiment, the synthesis can preferably take place in such a manner that medium-viscosity OH-terminated prepolymers are produced by reacting the polyols with a substoichiometric amount of diisocyanates in the presence of antimicrobial agents or biocides that have two or more functional groups that are capable of addition to isocyanate, or else by reacting the polyols with a substoichiometric amount of diisocyanates in combination with diols and/or triols as well with antimicrobial agents or biocides that have two or more functional groups that are capable of addition to isocyanate, after which the prepolymers are mixed with an external emulsifier, and then a diisocyanate, triisocyanate and/or polyisocyanate is added to bring about the later crosslinking of the OH-terminated prepolymers.

Examples of functional groups that are capable of addition to isocyanate are particularly hydroxy groups, amino groups, carboxy groups and/or sulfide groups, preferably hydroxy groups or amino groups.

The term antimicrobial agent refers to a substance that reduces or else eliminates or deactivates the reproduction capacity or infectiousness of microorganisms. Antimicrobial substances include antibiotics against bacteria as well as antimycotics against fungi and pathogenic yeasts. Moreover, all antiparasitics are included among the antimicrobial substances which, in turn, include antihelminthics against parasitic worms, and antiprotozoics against pathogenic amoeba. Aside from these substance groups, which serve for direct specific therapy, all disinfectants are also included among the antimicrobial substances. These can deactivate not only the above-mentioned pathogens but also viruses.

Biocides are active ingredients, chemicals and microorganisms employed in pest control in the non-agricultural sector against harmful organisms such as, for instance, rats, insects, fungi, microbes, that is to say, they include disinfectants, rat poisons or wood preservatives. The term biocides as employed here refers to active ingredients or preparations that are designed to chemically or biologically destroy, repel or render pests harmless by preventing their occurrence or combating them in some other way.

In the method described above, hydroxy-, amino-, carboxy- and/or sulfide-difunctionalized or polyfunctionalized antimicrobial agents or biocides react with the diisocyanates via an addition reaction analogously to the polyols that have been used and thus, without terminating the polymerization, are covalently incorporated into the prepolymer chains that are being formed. As a result, this compound becomes active upon contact, without being released or contaminating the environment.

Preferably, the antimicrobial agents or biocides employed are quaternary ammonium compounds or pyridinium compounds that, in their substituents, have at least one alkyl radical having a length equal to or greater than ten carbon atoms as well as two or more functional groups that are capable of addition to isocyanate, preferably OH groups or NH₂ groups.

The prepolymers that have been formed by means of the method are mixed with an external emulsifier and advantageously dispersed in water, thus forming low-viscosity emulsions with which textile fabrics can be impregnated very well.

Applicants have discovered that the preferably incorporated quaternary ammonium compounds, especially due to their surfactant-like or amphoteric structures, stabilize the aqueous dispersion and result in an improvement of the emulsibility of the prepolymers being used.

Advantageously, the above-mentioned antimicrobial agents or biocides are employed in an amount ranging from 2% to 15% by weight, preferably 5% to 10% by weight, relative to the total weight of the textile.

Below a value of 2% by weight, impregnation with the antimicrobial agent or biocide does not exhibit a particularly good antimicrobial or biocidal effect. Above 2% by weight, the desired antimicrobial or biocidal effect is achieved while, at the same time, the impregnated textile exhibits a soft and velvety hand.

The application in the form of the polyurethane emulsion entails the advantage of a uniform distribution of the antimicrobial or bactericidal finish on the surface of the fibers of the textiles.

The antimicrobial effect can be generally described as follows:

a) adsorption onto the surface,
b) diffusion through the cell wall,
c) binding to the cytoplasmic membrane,
d) destabilization of the cytoplasmic membrane,
e) release of K+ ions and other components of the cytoplasmic membrane, and
f) cell death, for example, of the bacteria cell.

In an embodiment, the emulsified OH-terminated prepolymers are crosslinked by means of the addition of diisocyanate, triisocyanate and/or polyisocyanate, and preferably by heating up the impregnated or coated textiles.

In another embodiment, the method for the production of a reactive polyurethane emulsion for the antimicrobial impregnation and/or coating of textile fabrics advantageously provides that medium-viscosity, OH-terminated prepolymers are produced by reacting the polyols with a substoichiometric amount of diisocyanates in combination with diols and/or triols, without the addition of an antimicrobial additive or biocide during the production of the prepolymer.

In an embodiment, the obtained prepolymers are emulsified analogously to the method described above and subsequently mixed with triisocyanate and/or polyisocyanate which, in contrast to the method described above, was reacted ahead of time—that is to say, after the emulsifying and before the mixing with triisocyanate and/or polyisocyanate, with a substoichiometric amount of an antimicrobial agent or biocide that has a functional group that is capable of addition to isocyanate.

Examples of a functional group that is capable of addition to isocyanate are particularly a hydroxy group, an amino group, a carboxy group and/or a sulfide group, preferably a hydroxy group or an amino group.

As described above, the production of the polyurethane prepolymers calls for a substoichiometric amount of NCO in order to obtain OH-terminated and thus storage-stable prepolymers. With a substoichiometric amount of NCO, however, it is not possible to ensure a complete incorporation in the case of a preceding addition of a monofunctionalized antimicrobial additive or biocide, especially in the case of an addition during the production of the prepolymer. The result would especially be monomeric, antimicrobial additives or biocides in the later emulsion as well as a reduced content of covalently bound antimicrobial agent or biocide in the prepolymer.

Diisocyanates are preferably not used for crosslinking the polyurethane emulsion here. Generally speaking, harder products would be obtained as a result of a linear chain lengthening. Crosslinking with a trifunctional or polyfunctional isocyanate gives rise to crosslinked systems that result in softer products. The reason for this is a disruption of the crystallization by the branchings.

In the case of the antimicrobial or biocidal finish, the use of diisocyanate could even cause chain breakage and thus a loss of the mechanical properties since an NCO group would react with the antimicrobial additive or biocide while the other NCO group would react with the OH-terminated prepolymer. As a result, an antimicrobial additive or biocide molecule would be incorporated at the chain end of the prepolymer molecule via a diisocyanate bridge, but a chain lengthening would no longer be possible.

In an embodiment of the method, a textile fabric is also preferably impregnated or coated with the reactive polyurethane emulsion and dried in order to achieve the post-crosslinking of the OH-terminated prepolymer.

Advantageously, the employed monofunctionalized antimicrobial agents or biocides are quaternary ammonium compounds or pyridinium compounds that have, in their substituents, at least one alkyl radical having a length equal to or greater than ten carbon atoms as well as a functional group that is capable of addition to isocyanate such as a hydroxyl group, an amino group, a carboxy group and/or a sulfide group. Special preference is given to an OH- or NH₂-monofunctionalized group.

In an embodiment, the reaction of the monofunctionalized quaternary ammonium compounds with the triisocyanates or polyisocyanates is preferably carried out in a nitrogen atmosphere in a preferably polar aprotic solvent, preferably at 60° C. [140° F.] over a period of two days. Of course, the reaction time can be markedly reduced by adding catalysts or by raising the temperature.

In an embodiment, the molar ratio of isocyanate groups to the functional group of the quaternary ammonium compound that is capable of addition to isocyanate is preferably within the range from 3:1.5 to 3:0.5, especially preferably within the range from 3:1.1 to 3:0.9

In principle, all polar aprotic solvents are a possibility as the solvent. Preference, however, is given to those that can easily be removed after the reaction has ended and that have the fewest effects that pose an occupational or environmental risk. In this context, particular preference is given to a solvent such as butylal.

Advantageously, the antimicrobial agents or biocides that have a functional group that is capable of addition to isocyanate are employed in an amount ranging from 2% to 15% by weight, preferably from 5% to 10% by weight, relative to the total weight of the textile.

Below a value of 2% by weight, impregnation with the antimicrobial agent or biocide does not display the desired antimicrobial or biocidal effect. Above 2% by weight, the desired antimicrobial or biocidal effect is achieved while, at the same time, the impregnated textile exhibits a soft and velvety hand.

For both synthesis methods, it holds true that the chemical incorporation of the antimicrobial additives or biocides into the polymer matrix provides the thus finished textile fabrics with a wash-resistant and therefore durable or permanent protection of the fabrics against microbial or biocidal attack.

Laundering experiments were carried out in which nonwovens on the basis of Evolon® (microfiber textile consisting of a polyester-polyamide blend made by the Freudenberg company) that had been impregnated with polyurethane emulsions underwent ten laundering cycles at temperatures of 40° C., 60° C. and 90° C. [104° F., 140° F. and 194° F.]. No removal of the coating from the fibers was observed in this process.

The drawbacks of commercially available fiber materials with antimicrobial finishing such as, for example, migration or washing-out of the biocides as well as the associated harm to the environment are prevented by the antimicrobial embodiment preferred according to the invention.

The use of textiles with an antimicrobial finish is on the rise nowadays. Reasons for this trend are efforts to reduce the occurrence of odor due to perspiration, to prevent infections or even to treat skin diseases such as neurodermititis.

Normally, such antimicrobially finished textiles are based on fiber materials to which either antimicrobial additives were admixed during the production process or whose surfaces were finished with coatings made of materials with an antimicrobial effect.

In the former case, systems are created very frequently with triclosan such as, for example, Rhovyl® AS (made by the Rhovyl company) or Amicor® (made by Ibena Textilwerke Beckmann GmbH), or with silver compounds such as, for instance, Meryl® Skinlife (made by the Nylstar company), Trevira bioactive (made by the Trevira company).

When it comes to fiber coatings, they are usually made on the basis of metals or metal salts. Examples of these are Padycare® products made by the Tex-A-Med company (silver-coated textiles) or R.STAT (fiber materials coated with copper sulfide). A general drawback of loading polymeric fiber materials with low-molecular antimicrobial substances is that they are not immobilized covalently, as a result of which they can be permanently removed from the textile due to laundering and migration processes. Over the course of time, this leads to an exhaustion of the active ingredient, thus rendering the material ineffective while also contaminating the environment. Similar problems are also encountered with other coated fibers since the coatings can be abraded off by mechanical stress such as, for example, when the garment is being worn or being laundered, since they are not covalently incorporated into the surrounding polymer matrix.

In a preferred alternative or cumulative embodiment of the method for the production of a reactive polyurethane emulsion or soft polyurethanes, especially for the flame-retardant and/or antimicrobial impregnation and/or coating of textile fabrics, a method for the hydrophilic finishing of textile fabrics is to be put forward.

Preferably, the method for the production of a reactive polyurethane emulsion for the hydrophilic impregnation and/or coating of textile fabrics is carried out in such a way that medium-viscosity, OH-terminated prepolymers are produced by reacting the polyols with a substoichiometric amount of diisocyanates in the presence of polar, non-ionic copolymers as the hydrophilic agent, or else by reacting the polyols with a substoichiometric amount of diisocyanates in combination with diols and/or triols as well as with polar, non-ionic copolymers as the hydrophilic agent, or else by reacting hydrophilic polyether polyols as the polyols with a substoichiometric amount of diisocyanates, after which the prepolymers are mixed with an external emulsifier, and then a diisocyanate, triisocyanate and/or polyisocyanate is added to bring about the later crosslinking of the OH-terminated prepolymers.

Here, the polar, non-ionic copolymers or the hydrophilic polyether polyols employed as the hydrophilic agents react with the diisocyanates via an addition reaction and are thus covalently incorporated into the prepolymer chain that is being formed. Subsequently, the prepolymers that have been formed are mixed with an external emulsifier and preferably dispersed in water, thus forming low-viscosity emulsions with which textile fabrics can be impregnated or coated extremely well.

The textile fabric impregnated or coated with the reactive polyurethane emulsion is dried by heating in order to crosslink the OH-terminated prepolymer. The term reactive polyurethane emulsions refers to emulsified OH-terminated prepolymers that have been mixed with diisocyanate, triisocyanate and/or polyisocyanate.

Preferably, hydrophilic polyether polyols on the basis of ethylene oxide and/or propylene oxide or their derivatives or copolymers having a molecular weight ranging from 400 to 6000 are employed as the hydrophilic agents.

Advantageously, hydrophilic polyether polyols having a molecular weight within the range from 600 to 2000 are employed which are incorporated covalently either into the main strand of the prepolymer molecule or else in the form of side chains. Special preference is given to the use of polyethylene glycol and/or polypropylene glycol, very special preference is given to the use of polyethylene glycol.

Due to the hydrophilic properties of the prepolymer, which are brought about by the incorporation of the non-ionic, polar copolymers, preferably of the polyethylene glycols, the emulsion is considerably easier to produce and it stands out for a substantially better storage stability, especially in comparison to hydrophobic systems. The phenomenon of the better storage stability can be explained by the fact that the incorporation of polar, non-ionic groups increases the repulsion forces between the polyurethane particles, as a result of which the tendency to agglomeration is reduced, thus stabilizing the emulsion.

The advantages of a non-ionic emulsion also include its stability vis-à-vis frost, pH changes and electrolyte addition.

When pure polyethylene glycols are used as the polyol basis, highly hydrophilic products are obtained which, however, can exhibit worse mechanical properties, for example, in terms of the abrasion behavior.

Therefore, special preference is given to a combination including polyols that tend to be hydrophobic and that have better mechanical properties in the final product, for example, in terms of the abrasion behavior, including, for instance, polycaprolactone and/or polytetrahydrofuran, and consisting of a hydrophilic polyether polyol, especially polyethylene glycol, in order to improve the hydrophilia.

Advantageously, the hydrophilic agents are employed in an amount within the range from 5% to 80% by weight, preferably from 5% to 35% by weight, relative to the total amount of prepolymer.

Below a value of 5% by weight, an impregnation with the hydrophilic agent does not display very good hydrophilic properties. Above 5% by weight, the desired hydrophilic properties are obtained while, at the same time, the impregnated textile exhibits a soft and velvety hand. Above 35% by weight, the textile remains soft due to the increased amount of impregnation but it then tends to feel more like rubber or silicone.

The chemical incorporation especially of polyethylene oxide units into the polymer matrix accounts for permanent hydrophilia. The storage stability of the emulsion is considerably better in comparison to its hydrophobic variants, which are based especially on the combination of hydrophobic polyols and polydimethyl siloxanes. In addition, the water vapor permeability of the impregnated textile is improved.

In a preferred alternative or cumulative embodiment of the method for the production of a reactive polyurethane emulsion or of soft polyurethanes, especially for the flame-retardant and/or antimicrobial impregnation and/or coating of textile fabrics, a method for the dirt-repellant finishing of textile fabrics is to be put forward with which it is possible to obtain a particularly cost-efficient and environmentally sound, uniformly distributed, highly wash-resistant and especially stain-resistant impregnation and/or coating of a wide array of textile fabrics, without having a detrimental effect on the soft character of the hand.

Preferably, the method for the production of a reactive polyurethane emulsion to create a dirt-repellant impregnation and/or coating of textile fabrics is carried out in such a manner that medium-viscosity, OH-terminated prepolymers are produced by reacting the polyols with a substoichiometric amount of diisocyanates in the presence of OH- or NH₂-difunctionalized or OH- or NH₂-polyfunctionalized dirt-repellant agents, or else by reacting the polyols with a substoichiometric amount of diisocyanates in combination with diols and/or triols as well as with OH- or NH₂-difunctionalized or OH- or NH₂-polyfunctionalized dirt-repellant agents, after which the prepolymers are mixed with an external emulsifier, and then a diisocyanate, triisocyanate and/or polyisocyanate is added to bring about the later crosslinking of the OH-terminated prepolymers.

The term dirt refers here to all unwanted foreign matter on textiles or other surfaces. Dirt is not a clearly definable substance since it is made up of many different individual components. A classification can be on the basis of the literature (Enders, H.; Wiest, H. K., Öl abweisende Ausrüstung mit Fluorchemikalien [Oil-repellant finishing with fluorochemicals], MTB 41 (1960), pages 1135 to 1144).

Here, the OH- or NH₂-difunctionalized or OH- or NH₂-polyfunctionalized dirt-repellant agents react with the diisocyanates via an addition reaction analogously to the polyols that have been used, and are thus covalently incorporated into the prepolymer chains that are being formed.

Subsequently, the prepolymers that have been formed are mixed with an external emulsifier and advantageously dispersed in water, thus forming low-viscosity emulsions with which textile fabrics can be impregnated extremely well.

In an embodiment, the textile fabric impregnated or coated with the reactive polyurethane emulsion is dried by heating in order to crosslink the OH-terminated prepolymer. The term reactive polyurethane emulsions refers to OH-terminated prepolymers mixed with diisocyanate, triisocyanate and/or polyisocyanate.

The application in the form of this polyurethane emulsion entails the advantage of a uniform distribution of the dirt-repellant agents or of the stain-resistant agent on the surface of the fibers of the textiles.

The chemical incorporation of the dirt-repellant agents into the polymer matrix ensures permanent and thus wash-resistant stain protection of the fibers.

Examples of dirt-repellant agents or stain-resistant agents include all molecules that improve the dirt-repellant properties of the later polyurethane and that, at the same time, have two or three reactive hydroxyl or amino groups at each of their ends or in the side chains that might be present.

Even though the paraffin emulsions and fat-modified cellulose crosslinkers employed as hydrophobing agents in the state of the art can attain a good water-repellant effect as well as high water-pressure resistance, their durability is limited, particularly after dry-cleaning operations.

In contrast, when it comes to dirt-repellant agents, preference is given here to fluorinated OH- or NH₂-difunctionalized or OH- or NH₂-polyfunctionalized polyols, especially linear or branched perfluoropolyols on the basis of fluorinated polymethylene oxide, polyethylene oxide, polypropylene oxide or polytetramethylene oxide or their copolymers, which are especially end-capped with ethylene oxide, said polyols having a molecular weight within the range from 500 to 6000, especially preferably within the range from 2000 to 3000.

In this context, mention should be made of commercially available fluorinated polyols, for instance, poly(ethylene oxide methylene oxide) copolymers, e.g. Fomblin® made by the Solvay Solexis company, and having the general molecular formula X—CF₂—O—(CF₂—CF₂—O)ₙ—(CF₂O)ₘ—CF₂—X, which are end-capped with reactive OH groups. The terminal groups X here correspond to the functional groups —CH₂—OH (Fomblin Z DOL 2000, 2500, 4000 made by the Solvay Solexis company), —CH₂—(O—CH₂—CH₂)ₚ—OH (Fomblin Z DOL TX made by the Solvay Solexis company), and —CH₂—O—CH₂—CH(OH)—CH₂—OH (Fomblin Z Tetraol made by the Solvay Solexis company).

Other suitable fluorinated polyols include, for example, the types L-12075 made by the 3M Corporation or the MPD polyols made by the DuPont company.

Aside from the completely fluorinated systems, suitable polyols are also those that have fluorinated side chains such as, for example, products made by the OMNOVA company and having the general molecular formula HO—[CH₂C(CH₃)(CH₂—O—CH₂—CF₃)CH₂—O]ₓ—CH₂—C(CH₃)₂—CH₂—[CH₂C(CH₃)(CH₂—O—CH₂—CF₃)CH₂]_{y}—OH and HO—[CH₂C(CH₃)(CH₂—O—CH₂—CF₂—CF₃)CH₂—O]ₓ—CH₂—C(CH₃)₂—CH₂—[O—CH₂C(CH₃)(CH₂—O—CH₂—CF₂—CF₃)CH₂]_{y}—OH, whereby the sum of x and y amounts to approximately 6 (PolyFox PF-636 and PolyFox PF-656) or 20 (PolyFox PF-6320 and PolyFox PF-6520).

In comparison to the completely fluorinated systems, the OMNOVA products can be more easily mixed with polyols but, due to the lower content of fluorinated carbon atoms, they have fewer dirt-repellant properties.

Advantageously, OH- or NH₂-difunctionalized or OH- or NH₂-polyfunctionalized dirt-repellant agents are employed in an amount within the range from 5% to 85% by weight, preferably from 10% to 20% by weight, relative to the total amount of prepolymer.

Below a value of 5% by weight, an impregnation with the dirt-repellant agent does not display a particularly good a stain-resistant effect. Above 5% by weight, the desired dirt-repellant properties are obtained while, at the same time, the impregnated textile exhibits a soft and velvety hand.

Preferred embodiments of the method for the production of reactive polyurethane emulsions or of soft polyurethanes either without or in combination with a flame-retardant, antimicrobial, hydrophilic or dirt-repellant finish are disclosed in the additional subordinate claims,

When it comes to the production of low-molecular prepolymers, preferably not only polyols that are short-chained and liquid at room temperature are used, but also polyols that are solid and have a higher-molecular weight at room temperature.

The methods preferably make use of hydrophobic polyols.

Advantageously, the methods make use of polyols on the basis of:

polyadipate having a molecular weight ranging from 400 to 6000,

polycaprolactone having a molecular weight ranging from 450 to 6000,

polycarbonate having a molecular weight ranging from 450 to 3000,

copolymers consisting of polycaprolactone and polytetrahydrofuran having a molecular weight ranging from 800 to 4000,

polytetrahydrofuran having a molecular weight ranging from 450 to 6000,

hydrophobic polyether polyol, especially polyether polyols having longer alkylene units than polyethylene glycol and polypropylene glycol as well as their copolymers, having a molecular weight ranging from 400 to 6000,

fatty acid esters having a molecular weight ranging from 400 to 6000, and/or polysiloxane functionalized with organic terminal groups and having a molecular weight ranging from 340 to 4500.

The polyols employed in each case are preferably provided in liquid form.

Advantageously, the polyols are reacted with the diisocyanates at a molar OH:NCO ratio of 2:1 to 6:5, either without or in combination with diols and/or triols as well as without or in combination with the OH-functionalized flame retardants, antimicrobial, hydrophilic or dirt-repellant agents.

This means that preferably

the polyols are reacted with the diisocyanates, or

the polyols are reacted in combination with diols and/or triols and with the diisocyanates, or else

combinations of polyols and OH-functionalized flame retardants, antimicrobial agents or biocides, dirt-repellant agents or hydrophilic agents, particularly polar, non-ionic copolymers such as especially polyether polyols, are reacted with the diisocyanates or

combinations of polyols, diols and/or triols as well as OH-functionalized flame retardants, antimicrobial agents or biocides, dirt-repellant agents or hydrophilic agents, particularly polar, non-ionic copolymers such as especially polyether polyols, are reacted with the diisocyanates at a molar OH:NCO ratio of 2:1 to 6:5.

The addition of an external emulsifier refers here to the fact that the OH-terminated prepolymers are mixed with an emulsifier that can be washed out, whereby the emulsifier is not incorporated into the polyurethane chain.

In this method step, owing to the complete reaction of the isocyanate with the polyol, the emulsifier cannot be incorporated into the polyurethane chain. A reaction of the free OH groups in the prepolymer with the emulsifier is not possible either.

It is significant that the prepolymer is first uniformly and thoroughly mixed with the emulsifier before preferably water is slowly added to the prepolymer-emulsifier mixture, preferably under the effect of shearing forces, particularly by means of high-speed agitation with a dispersion disk or with a centrifugal mixer. During or after the dispersion of the prepolymer in water, no chain-lengthening step is carried out. The term high-speed agitation refers here to approximately 400 to 1200 rpm. Special preference is given to the range from 600 to 800 rpm.

In another method step, diisocyanate, triisocyanate or polyisocyanate is then added to the prepolymer emulsion for purposes of later crosslinking.

Particularly for purposes of achieving good environmental compatibility and good lightfastness, it is advantageous to employ aliphatic, cycloaliphatic and/or non-aromatic heterocyclic diisocyanates for the reaction of the polyols with the diisocyanates, either without or in combination with diols and/or triols as well without or in combination with the OH-functionalized flame retardants, antimicrobial, dirt-repellant or hydrophilic agents. Preferably, hexamethylene diisocyanate, isophorone diisocyanate, 1,4-cyclohexane diisocyanate, 1-methyl-2,4-cyclohexane diisocyanate, 1-methyl-2,6-cyclohexane diisocyanate, 4,4′-dicyclohexyl methane diisocyanate, 2,4-dicyclohexyl methane diisocyanate, 2,2′-dicyclohexyl methane diisocyanate and/or their isomeric mixtures are used as diisocyanates.

This means that, preferably,

the polyols are reacted with the diisocyanates, or

the polyols are reacted in combination with diols and/or triols and the diisocyanates, or

combinations of polyols and OH-functionalized flame retardants, antimicrobial agents or biocides, dirt-repellant agents or hydrophilic agents, particularly polar, non-ionic copolymers such as especially polyethylene glycols, are reacted with the diisocyanates, or

combinations of polyols, diols and/or triols as well as OH-functionalized flame retardants, antimicrobial agents or biocides, dirt-repellant agents or hydrophilic agents, particularly polar, non-ionic copolymers such as especially polyethylene glycols, are reacted with the above-mentioned diisocyanates.

Preferably, in order to produce the OH-terminated prepolymers, the polyols are reacted with the diisocyanates either without or in combination with diols and/or triols as well as without or in combination with the OH-functionalized flame retardants, antimicrobial, dirt-repellant or hydrophilic agents at a temperature ranging from 80° C. to 140° C. [176° F. to 284° F.], preferably at 120° C. [248° F.].

Advantageously, the addition of a catalyst is not necessary.

After the complete reaction of the polyols and of the possible additional OH-functionalized agents with the diisocyanate, low-molecular prepolymers are obtained that still have free OH groups and that have a mean viscosity within the range from 5000 mPas to 30,000 mPas at 70° C. to 85° C. [158° F. to 185° F.], which are referred to here as medium-viscosity prepolymers.

Free and thus toxic isocyanate can no longer be detected in the obtained OH-terminated prepolymers after the reaction has been completed. Therefore, the measurement of the isocyanate content according to Spielberger (DIN 53185 (1974) or EN ISO 11909) can be employed as an evaluation criterion for a complete reaction of the educts.

The prepolymer is subsequently cooled down, preferably to approximately 80° C. [176° F.], a temperature at which the prepolymer has a mean viscosity within the range from 5000 mPas to 30,000 mPas. This viscosity has the advantage that no organic solvents are needed for dilution purposes in the subsequent emulsifying process, resulting in an especially environmentally sound method exclusively on the basis of water (so-called “green chemistry”).

In order to disperse the OH-terminated prepolymers in water, they are first mixed with an external emulsifier or emulsifier mixture. Here, the addition of an external emulsifier refers to the fact that the OH-terminated prepolymers are mixed with an emulsifier that can be washed out later on, whereas the emulsifier is not incorporated into the polyurethane chain. In this process step, due to the complete reaction of the isocyanate with the polyol, the emulsifier cannot be incorporated into the polyurethane chain. A reaction of the free OH groups in the prepolymer with the emulsifier is likewise not possible.

In a preferred embodiment of the method, 2.5 to 15 parts by weight, preferably 5 to 10 parts by weight, of emulsifier are employed relative to 100 parts by weight of prepolymer.

Preferably, anionic and/or non-ionic emulsifiers are used. Preferably, the method makes use of an emulsifier on the basis of fatty-alcohol ethoxylate and/or sodium lauryl sulfate.

Applicants have discovered that prepolymers containing antimicrobial or biocidal, quaternary ammonium compounds in their polymer chain exhibit a much better emulsifying behavior than comparable prepolymers without incorporated quaternary ammonium compounds. This behavior can be explained by the surfactant-like structure of the quaternary ammonium compounds. In other words, they function analogously to ionic emulsifiers such as, for instance, sodium lauryl sulfate, and thus fulfill a dual function as an incorporated emulsifier and biocide or antimicrobial agent.

Good results have been obtained particularly in the case of the desired hydrophilia of the impregnation and/or coating that is being formed, also with an emulsifier on the basis of castor oil ethoxylate, which is incorporated into the polymer network during the subsequent crosslinking to create the polyurethane impregnation and/or coating, thus further enhancing the hydrophilia of the impregnation and/or coating that is being formed.

A significant factor for all of the method variants is that the prepolymer is first thoroughly and uniformly mixed with the emulsifier before preferably water is slowly added to the prepolymer-emulsifier mixture, preferably under the effect of shearing forces, particularly by means of high-speed agitation with a dispersion disk or with a centrifugal mixer. During or after the dispersion of the prepolymer in water, no chain-lengthening step is carried out. The term high-speed agitation refers here to approximately 400 to 1200 rpm. Special preference is given to the range from 600 to 800 rpm.

In an embodiment, no chain-lengthening step is carried out during or after the dispersion of the prepolymer in water. Not until a subsequent method step is diisocyanate, diisocyanate or polyisocyanate added to the prepolymer emulsion for crosslinking purposes.

In an embodiment, the prepolymer-emulsifier mixture is preferably dispersed in water in amounts ranging from 55 to 120 parts by weight, preferably 70 to 100 parts by weight, relative to 100 parts by weight of prepolymer.

In an embodiment, the prepolymer emulsion can be produced with a prepolymer content preferably within the range from 50% to 60% by weight and a viscosity of less than 300 mPas. The high concentration is advantageous for the stability of the OH-terminated prepolymer emulsion as well as for the transport of the emulsion. Moreover, there is no need for water to be transported and the dilution can be carried out on site.

The OH-terminated prepolymers thus produced are storage-stable for several months in an aqueous emulsion at room temperature, they can be post-crosslinked with isocyanate and they are suitable for a cost-efficient impregnation and/or coating process. The use of preferably aliphatic and/or cycloaliphatic, non-aromatic diisocyanates allows the production of aliphatic OH-terminated prepolymers that, once they have been post-crosslinked with aliphatic isocyanates, also yield particularly environmentally sound and lightfast aliphatic polyurethanes.

For purposes of post-crosslinking the OH-terminated prepolymers, preferably aliphatic diisocyanate, triisocyanate and/or polyisocyanate is added. Advantageously, triisocyanates, preferably trimerisates on the basis of isophorone diisocyanate or else trimerisates of hexamethylene diisocyanate are employed.

In contrast to the aliphatic diisocyanates, the monomeric aliphatic triisocyanates are not toxic.

Moreover, the use of triisocyanate is characterized by an advantageous reactivity. The pot life of the mixture of the OH-terminated prepolymer dispersion with triisocyanate is relatively long at room temperature, and the OH-terminated prepolymer reacts quickly with triisocyanate at an elevated temperature.

Polyurethanes having especially good mechanical properties and a particularly high temperature-stability can be produced with triisocyanates.

In all of the method variants, for purposes of post-crosslinking the OH-terminated prepolymers, the isocyanate is preferably homogenized with the same emulsifier that is also used for the prepolymer dispersion.

In this context, preferably 5 to 50 parts by weight of emulsifier, preferably 15 to 25 parts by weight of emulsifier, relative to 100 parts by weight of isocyanate, are employed, and then added under agitation to the prepolymer dispersion in such amounts of that the equivalence ratio of the free OH groups in the prepolymer with respect to the isocyanate groups of the diisocyanate, triisocyanate and/or polyisocyanate is preferably selected within the range from 0.8:1.2 to 1:2, particularly preferably from 1:1.2 to 1:1.8, and very especially preferably from 1:1.5.

The polyurethane emulsion rendered reactive with isocyanate is storage-stable for several hours. The viscosity of the polyurethane emulsion is even below 500 mPas, depending on the value selected for the concentration for the impregnation process.

During this period of time, neither a change in the viscosity nor foam formation due to the reaction of water with isocyanate were observed.

In an especially advantageous embodiment of the method, textile fabrics such as, for instance, nonwovens, woven fabrics or knit fabrics, are impregnated or coated with the reactive polyurethane emulsion and subsequently dried.

Owing to the low viscosity of the emulsion, it is absorbed very well by the textile fabric during the impregnation.

The post-crosslinking of the still-free OH groups of the prepolymer with isocyanate in order to form a crosslinked polyurethane preferably takes place in a drying process at a temperature of 120° C. to 170° C. [248° F. to 338° F.], especially preferably from 150° C. to 160° C. [302° F. to 320° F.].

Preferably, no catalysts are needed for the fast post-crosslinking reaction, which is completely finished within a few minutes.

In all of the method variants, 1 mm-thick test films made of the crosslinked dried polyurethanes preferably display a Shore hardness A of 45 to 60, depending on the polyurethane synthesis, which is why they are referred to here as soft polyurethanes. In contrast, a Shore hardness A of more than 80 was measured in the test films that had been made according to the state of the art.

Due to the crosslinking of the long-chain polyurethane soft segment with isocyanate and without the familiar incorporation of the usual hard segments into the polyurethane chain, which are produced by reacting otherwise still free diisocyanate of isocyanate-terminated prepolymers with acid groups and with the chain-lengthening agent, the present polyurethanes have a low tendency to crystallization and thus also a pronounced softness and nevertheless, at the same time, they exhibit particularly good strength properties.

This effect is preferably promoted by the incorporation of a copolymeric flame retardant, biocide or antimicrobial, dirt-repellant or hydrophilic agent that disrupts the crystallization and thus additionally promotes the extraordinary softness of the product.

Applicants have observed that properties of a polyurethane system in water that has been rendered reactive with isocyanate can be explained by the fact that, due to the special synthesis of the polyurethane prepolymers, due to the selection of the non-incorporated emulsifiers and due to the fact that catalysts were not necessary, an ideal combination of the components was found for a cost-efficient and environmentally sound impregnation process, both for the prepolymer reaction and for the crosslinking reaction.

When the flame-retardant, antimicrobial, dirt-repellant or hydrophilic agents that are preferably employed here are covalently incorporated into the polymer matrix during the synthesis of the polyurethane, a permanent and thus wash-resistant flame-retardant protection, and protection against bacterial attack or dirt is formed on the textiles thus finished, or else textiles having particularly hydrophilic properties are created.

Due to their pronounced softness and hand, the textile fabrics treated with the reactive polyurethane emulsion are preferably made into leather-like, especially Nubuk-like or velvety products, for instance, by means of sanding, roughening and/or brushing.

The products impregnated and/or coated with the reactive polyurethane emulsion stand out not only for their particularly soft hand, except for the textiles that have been intentionally finished with hydrophilic agents, but also for a surface that is highly repellant to water and dirt.

Textile fabrics impregnated or coated with the reactive polyurethane emulsion or with the soft polyurethanes are used in technical, medical, civilian and/or military applications in the form of clothing such as uniforms, occupational safety garments or sportswear, upholstery, linings, fabrics for furniture covers, mattress covers and bed covers, curtains, blinds, wallpaper, bed linens, tents, backpacks, geotextiles, hygiene and cleaning articles such as filters or wipes.

Geotextiles are especially large-surface and permeable textiles that serve as construction material, for example, in the civil engineering, hydraulic engineering and road construction sectors as well as in the realms of agriculture, horticulture and farming, and they are preferably employed to separate, drain, filter, reinforce, protect, package and protect against erosion; depending on the application, they can be rendered flame-retardant as well as hydrophilic or dirt-repellant.

The textile products that have been rendered flame-retardant and/or dirt-repellant with the reactive polyurethane emulsion or with the soft polyurethanes are preferably employed in upholstery and linings such as, for instance, seat covers for cars, trains and airplanes, fabrics for furniture covers, mattress covers and bed covers, curtains, blinds, wallpaper, especially for so-called fire-retardant wallpaper, in backpacks, tents, in functional clothing such as uniforms, sportswear and occupational-safety garments, for instance, for firefighters or welders.

The term fire-retardant wallpaper refers, among other things, to nonwoven wallpaper that is rendered flame-retardant by means of a flame-retardant impregnation with polyurethane.

The products hydrophilically finished with the reactive polyurethane emulsion or with the soft polyurethanes are preferably employed in the form of work clothing as well as hygiene and cleaning articles such as, for example, wipes, or else for other applications in which hydrophilic and also soft, especially leather-like or velvety, coatings are desired.

The products antimicrobially finished with the reactive polyurethane emulsion or with the soft polyurethanes are preferably employed in the textile industry, in the form of sportswear, bed linens, hygiene articles as well as medical or technical applications such as filters or wipes.

Another advantage of the reactive polyurethane emulsions according to the invention in comparison to the polyurethane dispersions according to state of the art—except for the intentional hydrophilic finishing—is the very high wet strength and the very good wet abrasion resistance of the products thus treated. Since the emulsifiers, which have not been incorporated into the polyurethane chain, subsequently wash out of the impregnated or coated textile fabric, it can be seen that, during a wet treatment such as, for instance, washing or dry-cleaning, the products swell considerably less than products impregnated or coated with polyurethane dispersions from the state of the art, in which the polymers remain permanently hydrophilic due to the ionic groups incorporated into the polymer chain. Due to increased swelling in water, this permanent hydrophilia translates into reduced abrasion resistance.

As an alternative to the methods for hydrophilically finishing textile fabrics, optionally in addition to the above-mentioned methods for the production of a reactive polyurethane emulsion for the “general” flame-retardant, antimicrobial or dirt-repellant impregnation and/or coating of textile fabrics, a polysiloxane functionalized with organic terminal groups can be added to the at least one polyol or to the OH-terminated prepolymer that has reacted out.

Preferably, two possibilities exist for the use of functionalized polysiloxane.

On the one hand, the incorporation of functionalized polysiloxane into the polyurethane chain during the prepolymer reaction can take place through a combination with additional polyol and a reaction with isocyanate.

On the other hand, functionalized polysiloxane can be incorporated into the polyurethane chain in a crosslinking step in that the OH-terminated prepolymer that has reacted out is homogenized with functionalized polysiloxane prior to the emulsification.

The polysiloxane chains require organic terminal groups such as, for example, polyethylene glycol, polypropylene glycol or polycaprolactone.

Advantageously, OH-terminated polysiloxanes having a molecular weight ranging from 340 to 4500 are employed as functionalized polysiloxanes.

Owing to the additionally freely selectable incorporation of OH-functionalized polysiloxane, the crosslinked polyurethane becomes particularly soft and water-repellant. Accordingly, the impregnated textile also has a very soft hand and it is repellant to water as well as dirt.

In contrast, in the chemistry of conventional polyurethane dispersions and polyurethane solutions, the silicon content is frequently prescribed and limited. In these cases, silicon is often added as an additive to the polyurethane dispersions and polyurethane solutions, as a result of which it is not incorporated into the polyurethane chain and can therefore migrate. The silicon incorporation in conventional polyurethane dispersions often yields polyurethane having worse resistance properties. The stability of the dispersions is usually also detrimentally affected by siloxane, so that the content of ionic groups has to be increased, which translates into lower wet abrasion resistance.

A higher siloxane content is less critical in the case of polyurethane systems with incorporated, functionalized siloxane. Owing to the special combination of the polyurethane raw materials and the systematic crosslinking of the polyurethane chains, good values for the resistance and elongation at break as well as sometimes a softer product are achieved, even in the case of a higher siloxane content.

The subject matter of the invention will be explained in greater detail below on the basis of a number of examples.

### Example 1

### Production of the Reactive Polyurethane Emulsion

1000 parts by weight of polytetrahydrofuran (molecular weight of 2000 g/mol, OH number of 56) and 98.3 parts by weight of 4,4′-dicyclohexyl methane diisocyanate (molecular weight of 262 g/mol, NCO content of 31.8%),

wherein the molar ratio of polyol to isocyanate is 4 to 3,
are reacted in a reactor under intense agitation over the course of 2.5 hours at 120° C. [248° F.] to form a prepolymer that still has free OH groups.
Free isocyanate can no longer be detected using a titrimetric method according to Spielberger.

The prepolymer is cooled down to 80° C. [176° F.], whereby its viscosity amounts to 8400 mPas, and the prepolymer is mixed with an emulsifier mixture consisting of 1.5 parts by weight of an emulsifier with an anionic and non-ionic content on the basis of castor oil ethoxylate and 4.5 parts by weight of an emulsifier on the basis of sodium lauryl sulfate, relative to 100 parts by weight of prepolymer.

For purposes of dispersing the prepolymer in water, 120 parts by weight of water relative to 100 parts by weight prepolymer are added to the prepolymer-emulsifier mixture under high-speed agitation with a dispersion disk.

The term high-speed agitation refers here to approximately 400 to 1200 rpm. Special preference is given to the range from 600 to 800 rpm.

The result is an emulsion with a prepolymer content of 45% and a viscosity of 185 mPas that is storage-stable for 12 weeks at room temperature.

In another method step, 1000 parts by weight of the OH-terminated prepolymer emulsion described above, 28.2 parts by weight of a crosslinker mixture consisting of 22.5 parts by weight of a trimerisate on the basis of hexamethylene diisocyanate (molecular weight of 504 g/mol, NCO content of 22% and functionality of 3), and 5.7 parts by weight of an emulsifier on the basis of sodium lauryl sulfate are added under agitation.

The reactive emulsion is storage-stable for 5 hours at room temperature and can be diluted with water to the desired concentration in order to be further processed.

### Impregnation of a Nonwoven

A nonwoven, made of a filament pile consisting of polyester amide bicomponent continuous filament having a weight per unit area of 175 g/m² is subjected to a water-jet needling procedure and exhibits a titer of less than 0.2 dtex due to the splitting of the initial filaments. This nonwoven is impregnated with the above-mentioned reactive polyurethane emulsion, which was diluted with water to a prepolymer content of 20%, then impregnated in a padding machine by impregnating the nonwoven with the reactive emulsion, and subsequently the excess emulsion is squeezed out between two rollers at a compressive force of 2 bar. The impregnated nonwoven is tempered in an oven for 6 minutes at 120° C. [248° F.] in order to dry the nonwoven and to post-crosslink the OH-terminated prepolymer.

The result is an impregnated nonwoven with a polyurethane content of 28%.

Subsequent sanding of the nonwoven yields a Nubuk-like surface that stands out for its soft, warm and velvety hand.

### Impregnation of a Woven Fabric

A polyester blended fabric having a weight per unit area of 158 g/m², a fabric thickness of 480 mm and a thread diameter of 3.8μ as well as 16.5μ is impregnated with the above-mentioned reactive polyurethane emulsion, which was diluted with water to a prepolymer content of 25%, then impregnated in a padding machine according to the method described above and subsequently tempered in an oven for 6 minutes at 120° C. [248° F.] for the drying procedure and the secondary reaction.

The polyurethane content of the impregnated woven fabric is 17%. The impregnated woven fabric is especially characterized by its high degree of softness and its elastic behavior. In spite of the high degree of softness, when the woven fabric is wadded up, scrunched up or crumpled and subsequently released, the fabric springs back quickly and the surface spontaneously smoothes out without leaving any permanent creases, in contrast to the non-impregnated woven fabric, in which the creases created by the compression are left behind for several hours. Subsequent sanding of the surface of the impregnated woven fabric yields a soft, velvety hand.

### Example 2

### Production of the Reactive Polyurethane Emulsion

840 parts by weight of copolymer made of polycaprolactone and polytetrahydrofuran (molecular weight of 2000 g/mol, OH number of 54),

160 parts by weight of a polysiloxane functionalized with OH-terminal groups (molecular weight of 3000 g/mol, OH number of 34), and
84.5 parts by weight of isophorone diisocyanate (molecular weight of 222 g/mol, NCO content of 37.6%),
wherein the molar ratio of polyol to isocyanate is 4 to 3,
are reacted in a reactor under intense agitation over the course of 3 hours at 120° C. [248° F.] to form a prepolymer that still has free OH groups.
Free isocyanate can no longer be detected.

The prepolymer is cooled down to 80° C. [176° F.], whereby its viscosity amounts to 14,000 mPas, and the prepolymer is mixed together with 5.5 parts by weight of an emulsifier on the basis of sodium lauryl sulfate, relative to 100 parts by weight of prepolymer.

The dispersion of the prepolymer in water is carried out under high-speed agitation with a dispersion disk while slowly adding 100 parts by weight of water relative to 100 parts by weight of prepolymer.

The result is an emulsion with a polymer content of 50% and a viscosity of 235 mPas that is storage-stable for 12 weeks at room temperature.
The term high-speed agitation refers here to approximately 400 to 1200 rpm. Special preference is given to the range from 600 to 800 rpm.

In another method step, 1000 parts by weight of the OH-terminated prepolymer emulsion described above, 31.3 parts by weight of the crosslinker mixture consisting of 25 parts by weight of a trimerisate on the basis of hexamethylene diisocyanate (molecular weight of 504 g/mol, NCO content of 22% and functionality of 3), and 6.3 parts by weight of an emulsifier on the basis of sodium lauryl sulfate are added under agitation.

The reactive emulsion is storage-stable for 5 hours at room temperature and can be diluted with water to the desired concentration in order to be further processed.

### Example 3

### Production of the Reactive Polyurethane Emulsion

600 parts by weight of polycarbonate (molecular weight of 2000 g/mol, OH number of 57),

400 parts by weight of copolymer made of polycaprolactone and polytetrahydrofuran (molecular weight of 2000 g/mol, OH number of 54),
22.3 parts by weight of trimethylol propane (molecular weight of 134 g/mol), and
111 parts by weight of isophorone diisocyanate (molecular weight of 222 g/mol, NCO content of 37.6%),
wherein the molar ratio of polyol to isocyanate is 4 to 3,
are reacted in a reactor under intense agitation over the course of 2.5 hours at 120° C. [248° F.] to form a prepolymer that still has free OH groups.
Free isocyanate can no longer be detected.

The prepolymer is cooled down to 80° C. [176° F.], whereby its viscosity amounts to 20,000 mPas, and the prepolymer is mixed with 4.5 parts by weight of an emulsifier on the basis of sodium lauryl sulfate, relative to 100 parts by weight of prepolymer.

The dispersion of the prepolymer in water is carried out under high-speed agitation with a dispersion disk while slowly adding 120 parts by weight of water relative to 100 parts by weight of prepolymer.

The term high-speed agitation refers here to approximately 400 to 1200 rpm. Special preference is given to the range from 600 to 800 rpm.

The result is an emulsion with a prepolymer content of 45% and a viscosity of 210 mPas that is storage-stable for 12 weeks at room temperature.

In another method step, 1000 parts by weight of the OH-terminated prepolymer emulsion described above, 30.5 parts by weight of the crosslinker mixture consisting of 24.4 parts by weight of a trimerisate on the basis of hexamethylene diisocyanate (molecular weight of 504 g/mol, NCO content of 22% and functionality of 3), and 6.1 parts by weight of an emulsifier on the basis of sodium lauryl sulfate are added under agitation.

The reactive emulsion is storage-stable for 5 hours at room temperature and can be diluted with water to the desired concentration in order to be further processed.

### Example 4

### Production of a Reactive, Hydrophilic Polyurethane Emulsion

900 parts by weight of polycaprolactone and polytetrahydrofuran (molecular weight of 2000 g/mol, OH number of 56),

100 parts by weight of polyethylene glycol 600 (molecular weight of 600 g/mol, OH number of 187), and
142.4 parts by weight of 4,4′-dicyclohexyl methane diisocyanate (molecular weight of 262 g/mol, NCO content of 31.8%),
wherein the molar ratio of polyols to isocyanate is 5 to 4,
are reacted in a reactor under intense agitation over the course of 3 hours at 120° C. [248° F.] to form a prepolymer that still has free OH groups.
Free and thus toxic isocyanate can no longer be detected.

The prepolymer is cooled down to 80° C. [176° F.] and the prepolymer is mixed with 6 parts by weight of an emulsifier preferably on the basis of castor oil ethoxylate, relative to 100 parts by weight of prepolymer.

The dispersion of the prepolymer in water is carried out under high-speed agitation with a dispersion disk while slowly adding 100 parts by weight of water relative to 100 parts by weight of prepolymer.

The term high-speed agitation refers here to approximately 400 to 1200 rpm. Special preference is given to the range from 600 to 800 rpm.

The result is an emulsion with a prepolymer content of 50% and a viscosity of 230 mPas that is storage-stable for 12 weeks at room temperature.

In another method step, 1000 parts by weight of the OH-terminated prepolymer emulsion described above, 28.3 parts by weight of the crosslinker mixture consisting of 23.6 parts by weight of a trimerisate on the basis of hexamethylene diisocyanate (molecular weight of 504 g/mol, NCO content of 22% and functionality of 3), and 4.72 parts by weight of an emulsifier preferably on the basis of castor oil ethoxylate are added under agitation.

The reactive emulsion is storage-stable for several hours at room temperature and can be diluted with water to the desired concentration in order to be further processed.

TABLE 1
Film properties

| Properties | Test method | Example 1 | Example 2 | Example 3 |
|---|---|---|---|---|
| Hardness (Shore A) | | 52 | 45 | 50 |
| Modulus 50% (MPa) | DIN 53504 | 1.1 | 0.8 | 1.4 |
| Modulus 100% (MPa) | DIN 53504 | 3.5 | 2.3 | 3.4 |
| Tensile strength (MPa) | DIN 53504 | 13.2 | 10.8 | 11.9 |
| Elongation at break | DIN 53504 | 580 | 445 | 485 |
| (%) | | | | |
| Lightfastness | DIN EN ISO | 7-8 | 7-8 | 7-8 |
| | 105-B02 | | | |
| Volume swelling, | | 45 | 54 | 39 |
| 2 hours at room | | | | |
| temperature in | | | | |
| ethyl acetate (%) | | | | |
| Volume swelling, | | <0.1 | <0.1 | <0.1 |
| 16 hours at room | | | | |
| temperature in | | | | |
| water (%) | | | | |

| | Impranil LP | |
|---|---|---|
| Properties | RSC 1997 | Impranil 43032 |
| Hardness (Shore A) | 92 | 100 |
| Volume swelling, 2 hours at room | 200 | 95 |
| temperature in ethyl acetate (%) | | |
| Volume swelling, 16 hours at room | 8 | 25 |
| temperature in water (%) | | |

Impranil LP RSC 1997 (Bayer company): ionic/non-ionic polycarbonate ester-polyurethane with a solids content of 40%
Impranil 43032 (Bayer company): anionic, aliphatic polyester-polyurethane with a solids content of 30%

Table 1 shows the film properties of the reactive polyurethane emulsions according to the invention and indicated in Examples 1 to 3 as well as the polyurethane dispersions according to the state of the art.

For this purpose, water was evaporated out of the polyurethane dispersions of Examples 1 to 3 until a 1 mm-thick test film was obtained.

The data in Table 1 shows that the polyurethane test films according to the invention have a Shore hardness A of 45 to 52, whereas a Shore hardness A of more than 90 was measured in the test films that were made according to the state of the art. The soft polyurethanes produced according to the invention not only exhibit a special softness but, at the same time, they have particularly good resistance properties as well as good lightfastness.

The data from Table 1 also shows that the soft polyurethanes display considerably less volume swelling than the polyurethanes according to the state of the art, in which the polymers remain permanently hydrophilic owing to the ionic group that is incorporated into the polymer chain. This leads to increased swelling as well as to a reduced abrasion resistance.

TABLE 2
Surface wettability with water by means of contact angle
measurement on lying drops (apparatus: Dataphysics
OCAH 200; droplet size of 4 μl)

| Impregnated polyester | |
|---|---|
| woven fabric with | Contact angle |
| Example 1: | |
| 11% polyurethane content | 130, 130, 133 |
| 17% polyurethane content | 141, 139, 138 |
| 29% polyurethane content | 143, 141, 139 |
| Example 2: | |
| 10% polyurethane content | 141, 139, 139 |
| 19% polyurethane content | 143, 145, 142 |
| 31% polyurethane content | 149, 148, 151 |
| Example 3: | |
| 13% polyurethane content | 140, 139, 142 |
| 21% polyurethane content | 142, 144, 144 |
| 28% polyurethane content | 146, 145, 146 |
| Example 4 (hydrophilic): | |
| 23% polyurethane content | drop spreads quickly |
| 39% polyurethane content | drop spreads quickly |
| Impranil LP RSC 1997 | |
| 16% polyurethane content | drop spreads quickly |
| 29% polyurethane content | drop spreads slowly |
| Impranil 43032 | |
| 14% polyurethane content | drop spreads quickly |
| 32% polyurethane content | drop spreads quickly |

Table 2 shows the surface wettability with water of polyester woven fabrics that were impregnated with the reactive polyurethane emulsion indicated in Examples 1 to 4 according to the method analogous to Example 1 as well as those impregnated with Impranil dispersions (see Table 1) from the state of the art.

As the data in Table 2 shows, the products of Examples 1 to 3 impregnated with the reactive polyurethane emulsion, that is to say, without the hydrophilic finish according to Example 4, are characterized by a highly water-repellant as well as dirt-repellant surface.

TABLE 3
Abrasion resistance

| Impregnated nonwoven with | Abrasion test |
|---|---|
| Example 1: 28% polyurethane content | no hole formation |
| Example 2: 31% polyurethane content | no hole formation |
| Example 3: 28% polyurethane content | no hole formation |

Abrasion test according to Martindale, DIN 53863, 25,000 cycles at a compressive force of 12 kPa

Table 3 shows the abrasion resistance of fabrics that were impregnated with the reactive polyurethane emulsion indicated in Examples 1 to 3 according to the method analogous to Example 1.

The fabrics that were impregnated with the reactive polyurethane emulsion did not exhibit any hole formation or visible surface changes in the abrasion test, so that they have a particularly good abrasion resistance.

In contrast, fabrics that were impregnated with the dispersions Impranil LP RSC 1997 (Bayer company) and Impranil 43032 (Bayer company) exhibit at least brightened or shiny spots after an abrasion test.

### Example 5

### Production of a Reactive, Flame-Retardant Polyurethane Emulsion

500 parts by weight of a copolymer made of polycaprolactone and polytetrahydrofuran (molecular weight of 2000 g/mol, OH number of 56),

500 parts by weight of AFLAMMIT PLF 140 (phosphate oligomer approximately OH-difunctionalized and made by Thor Chemie GmbH) (OH number of 5), and
57.5 parts by weight of 4,4′-dicyclohexyl methane diisocyanate (molecular weight of 262 g/mol, NCO content of 31.8%),
wherein the molar ratio of polyols to isocyanate is 5 to 4,
are heated to 100° C. [212° F.] in a reactor. Under intense agitation, the temperature is raised to 120° C. [248° F.] over the course of 3 hours. In this process, the educts react to form a prepolymer that still has free OH groups.
Free and thus toxic isocyanate can no longer be detected.

Since the AFLAMMIT PLF 140 reacts relatively slowly, the incorporation into the prepolymer strand can be accelerated considerably by adding 0.1% to 0.2% by weight of a catalyst such as, for instance, triethylene diamine (PC CAT® TD30 made by the Nitroil company), relative to the total amount of prepolymer.

The prepolymer is preferably cooled down to 80° C. [176° F.] and then mixed with 6 parts by weight of an emulsifier preferably on the basis of sodium lauryl sulfate, relative to 100 parts by weight of prepolymer.

The dispersion of the prepolymer in water is carried out either under high-speed agitation with a dispersing disk or else with a centrifugal mixer while slowly adding 100 parts by weight of water, relative to 100 parts by weight of prepolymer.

The term high-speed agitation refers here to approximately 400 to 1200 rpm. Special preference is given to the range from 600 to 800 rpm.

The result is an emulsion with a prepolymer content of 50% and a viscosity of 240 mPas that is storage-stable for 12 weeks at room temperature.

In another method step, 1000 parts by weight of the OH-terminated prepolymer emulsion described above, 22 parts by weight of a crosslinker mixture consisting of 18.0 parts by weight of a trimerisate on the basis of hexamethylene diisocyanate (molecular weight of 504 g/mol, NCO content of 22% and functionality of 3), and 4.0 parts by weight of an emulsifier preferably on the basis of sodium lauryl sulfate are added under agitation.

The reactive emulsion is storage-stable for several hours at room temperature and can be diluted with water to the desired concentration in order to be further processed.

With the method analogous to Example 1, the reactive emulsion described in Example 5 is used to impregnate the textile fabric, nonwoven and polyester woven fabric described in Example 1.

As the test below demonstrates, a flame-retardant impregnation is obtained.

The burning behavior of impregnated and non-impregnated Evolon® nonwovens (microfiber textile consisting of a polyester-polyamide blend made by the Freudenberg company) is determined on the basis of DIN standard 75200, Bestimmung des Brennverhaltens von Werkstoffen der Kraftfahrzeuginnenaustattung [Determination of burning behavior of interior materials in motor vehicles], whose content is based on the American Federal Motor Vehicle Safety Standard FMVSS 302.

For this purpose, DIN A4 samples made of Evolon® were prepared in the manner described in Example 5 with a flame-retardant finish employing 50%, 40% and 30% emulsions. This was done on a laboratory padding machine at roller pressures of 0.5 bar, 1 bar, 1.5 bar, 2 bar, 2.5 bar and 3 bar. This yielded Evolon nonwovens having different contents of flame-retardant polyurethane impregnation agent. The content of flame-retardant polyurethane impregnation agent was determined by weighing the nonwoven before and after the impregnation. On the basis of the formulation, the actual content of flame retardant can then be calculated from this.

The DIN A4 samples were each used to create test specimens having a width of 70 mm and a length of 297 mm. Prior to the test, these test specimens were stored in accordance with the standard for 24 hours at a temperature of 23° C.±2° C. [73.4° F.±3.6° F.] and at a relative humidity of 50%±6%.

Subsequently, the specimens were clamped in a specimen holder which, in accordance with the standard, consists of two U-shaped corrosion-proof metal plates (frame). The precise dimensions of the specimen holder correspond to the values indicated in standard DIN 75200 and can be found there in the form of construction plans.

The specimen holder was subsequently placed under a laboratory exhaust hood and the fan of the air-exhaust system was switched on.

A Bunsen burner was used whose inner tube had a diameter of 9.5 mm. It was adjusted in such a way that the center of the nozzle was 19 mm below the center of the lower edge of the free end of the specimen. The total flame was set at a height of about 38 mm and the air inlet of the burner was closed. Before each flammability test, the burner had to be left burning for at least one minute in order to stabilize the flame.

Subsequently, the test specimen was exposed to the gas flame for 15 seconds in that the specimen holder was pushed above the Bunsen burner (center of the nozzle 19 mm below the center of the lower edge of the free end of the specimen). The Bunsen burner was switched off after this period of time.

The measurement of the burning time started at the moment when the flame had reached the first measuring mark. According to the standard, the measurement of the burning time has to be ended when the flame has reached the last measuring mark or else if the flame is extinguished before reaching the last measuring mark. If the flame does not reach the last measuring mark, a measurement is made of the burning distance that the flame has traveled until it is extinguished. Here, the burning distance is the degraded part of the test specimen that is destroyed on its surface or interior by the burning.

No burning time is measured if the specimen is ignited and no longer continues to burn after the ignition flame has been extinguished or if it is extinguished before the first measuring mark is reached. In such cases, the “burning rate=0” is entered into the test report. The burning rate in millimeters per minute results from the length of the burning distance in millimeters divided by the time in seconds for the burning distance, multiplied by 60.

TABLE 4
Fire behavior

| Specimen (content of | Burning segment | Burning time | Burning rate |
|---|---|---|---|
| flame retardant in %) | [mm] | [s] | [mm/min] |
| Evolon ® (untreated) | 257 | 61.5 | 250.7 |
| Evolon ® (25.0%) | 0 | 0 | 0 |
| Evolon ® (23.0%) | 1 | 5 | 12 |
| Evolon ® (22.0%) | 1 | 4 | 15 |
| Evolon ® (20.0%) | 0 | 0 | 0 |
| Evolon ® (17.7%) | 0 | 0 | 0 |
| Evolon ® (16.1%) | 0 | 0 | 0 |
| Evolon ® (15.5%) | 0 | 0 | 0 |
| Evolon ® (14.2%) | 0.7 | 3 | 14 |

Evolon ® (microfiber nonwoven consisting of a polyester-polyamide blend made by the Freudenberg company).

Table 4 shows the measuring results on the fire behavior of an untreated nonwoven and of a nonwoven that was impregnated with a flame-retardant, reactive polyurethane emulsion according to Example 5.

The data in Table 4 shows that the flame retardant used is especially preferably employed in an amount ranging from 14% to 25% by weight, relative to the total weight of the textile.

A stopwatch that can measure to a precision of 0.5 seconds was used to measure the burning time.

### Example 6

### Production of an Antimicrobial Reactive Polyurethane Emulsion

900 parts by weight of a copolymer made of polycaprolactone and polytetrahydrofuran (molecular weight of 2000 g/mol, OH number of 56), and

100 parts by weight of polysiloxane functionalized with OH-terminal groups (molecular weight of 4000 g/mol, OH number of 28) are prepared and homogenized at 120° C. [° C. [248° F.].

Subsequently,

100 parts by weight of 4,4′-dicyclohexyl methane diisocyanate (molecular weight of 262 g/mol, NCO content of 31.8%) are added, wherein the molar ratio of polyols to isocyanate is 5 to 4. The mixture undergoes intense agitation over the course of 2 hours in a reactor at a temperature of 120° C. [248° F.]. In this process, the educts react to form a prepolymer that still has free OH groups.
Free and thus toxic isocyanate can no longer be detected.

The prepolymer is cooled down preferably to 80° C. [176° F.], and the prepolymer is mixed with 6 parts by weight of an emulsifier mixture preferably on the basis of sodium lauryl sulfate, relative to 100 parts by weight of prepolymer.

The dispersion of the prepolymer in water is carried out under high-speed agitation with a dispersion disk while slowly adding 100 parts by weight of water relative to 100 parts by weight of prepolymer.

The term high-speed agitation refers here to approximately 400 to 1200 rpm. Special preference is given to the range from 600 to 800 rpm.

The result is an emulsion with a prepolymer content of 50% and a viscosity of 250 mPas that is storage-stable for 12 weeks at room temperature.

In another method step, 1000 parts by weight of the OH-terminated prepolymer emulsion described above, 100 parts by weight of a crosslinker mixture consisting of 76.1 parts by weight of a trimerisate on the basis of hexamethylene diisocyanate (molecular weight of 504 g/mol, NCO content of 22% and functionality of 3), which were previously reacted according to the procedure described below with the OH-monofunctionalized antimicrobial agent (molecular weight of 896 g/mol, NCO content of 9.4% and functionality of 2), and 23.9 parts by weight of an emulsifier preferably on the basis of sodium lauryl sulfate are added under agitation.

The reactive emulsion is storage-stable for several hours at room temperature and can be diluted with water to the desired concentration in order to be further processed.

### Production of the OH-Monofunctionalized Antimicrobial Agent

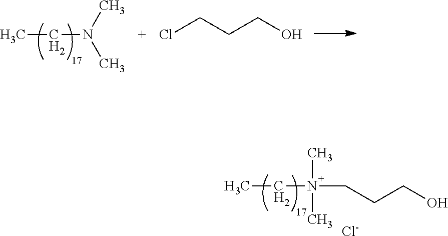

174 grams (520 mmol) of N,N-dimethyloctadecyl amine and 50 grams (520 mmol) of 3-chloro-1-propanol were reacted at 80° C. [176° F.] in a glass reactor over the course of 72 hours. The resultant colorless solid was crushed with a mortar and pestle and washed twice with 250 milliliters of diethyl ether. The yield was 183.8 grams (90% of the theoretical value).

Reaction of the OH-Monofunctionalized Antimicrobial Agent with the Hexamethylene-Diisocyanate Trimer (HDT)

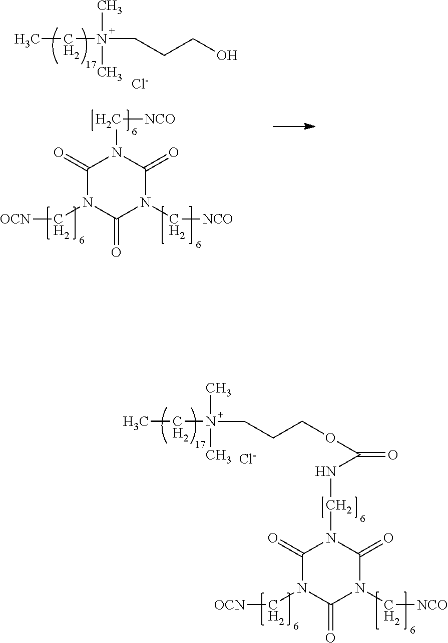

100 grams of Tolonate HDT (molecular weight of 504 g/mol, 198.4 mmol) are placed into 100 milliliters of butylal at 60° C. [140° F.] under a nitrogen atmosphere and mixed with 25.9 grams of the antimicrobial agent (molecular weight of 392 g/mol, 66.1 mmol) as well as with 2 drops of a catalyst, for instance, triethylene diamine (PC CAT® TD30 made by the Nitroil company). Subsequently, the mixture was stirred for two days at 60° C. [140° F.] under an inert-gas atmosphere.

### Example 7

### Production of a Reactive, Highly Dirt-Repellant Polyurethane Emulsion

800 parts by weight of a copolymer made of polycaprolactone and polytetrahydrofuran (molecular weight of 2000 g/mol, OH number of 56), and
100 parts by weight of polysiloxane functionalized with OH-terminal groups (molecular weight of 4000 g/mol, OH number of 28), and
   100 parts by weight of the polyether Formblin Z DOL 2000, which is perfluorinated except for the terminal groups (—CH₂—OH), are prepared and homogenized at 120° C. [248° F.].

Subsequently,

94 parts by weight of 4,4′-dicyclohexyl methane diisocyanate (molecular weight of 262 g/mol, NCO content of 31.8%) are added, wherein the molar ratio of polyols to isocyanate is 4 to 3. The mixture undergoes intense agitation over the course of 2.5 hours in a reactor at a temperature of 120° C. [248° F.]. In this process, the educts react to form a prepolymer that still has free OH groups.
Free and thus toxic isocyanate can no longer be detected.

The prepolymer is cooled down preferably to 80° C. [176° F.], and the prepolymer is mixed with 6 parts by weight of an emulsifier mixture preferably on the basis of sodium lauryl sulfate, relative to 100 parts by weight of prepolymer.

The dispersion of the prepolymer in water is carried out under high-speed agitation with a dispersion disk while slowly adding 100 parts by weight of water relative to 100 parts by weight of prepolymer.

The term high-speed agitation refers here to approximately 400 to 1200 rpm. Special preference is given to the range from 600 to 800 rpm.

The result is an emulsion with a prepolymer content of 50% and a viscosity of 250 mPas that is storage-stable for 12 weeks at room temperature.

In another method step, 1000 parts by weight of the OH-terminated prepolymer emulsion described above, 50 parts by weight of a crosslinker mixture consisting of 40.8 parts by weight of a trimerisate on the basis of hexamethylene diisocyanate (molecular weight of 504 g/mol, NCO content of 22% and functionality of 3), and 9.2 parts by weight of an emulsifier on the basis of sodium lauryl sulfate are added under agitation.

The reactive emulsion is storage-stable for several hours at room temperature and can be diluted with water to the desired concentration in order to be further processed.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

1-32. (canceled)

33. A method for production of a reactive polyurethane emulsion for use in impregnating and/or coating a textile fabric, the method comprising:
reacting polyols alone or in combination with at least one of diols and triols with a substoichiometric amount of diisocyanates so as to form medium-viscosity, OH-terminated prepolymers;
mixing the prepolymers with an external emulsifier; and
adding at least one of a diisocyanate, a triisocyanate and a polyisocyanate so as to bring about a crosslinking of the prepolymers.

34. The method as recited in claim 33, wherein the reacting is performed in the presence of one of OH- or NH₂-difunctionalized and OH- or NH₂-polyfunctionalized flame retardants.

35. The method as recited in claim 34, wherein the flame retardants include at least one of:
OH- or NH₂-di-terminated or OH- or NH₂-tri-terminated phosphinoxides,
OH- or NH₂-di-terminated or OH- or NH₂-tri-terminated phosphatoligomers,
OH- or NH₂-di-terminated or OH- or NH₂-tri-terminated triarylphosphates,
OH- or NH₂-di-terminated diarylalkyl phosphates, and
reactive POW-phosphorus polyols.

36. The method as recited in claim 35, wherein a weight of the flame retardants ranges from 10% to 50% relative to a total weight of the textile.

37. The method as recited in claim 33, wherein the reacting is performed in the presence of at least one of an antimicrobial agent and a biocide having at least two functional groups capable of being added to isocyanate.

38. The method as recited in claim 37, wherein the at least one of the antimicrobial agent and the biocide include at least one of a quaternary ammonium compound and a pyridinium compound having, as a substituent, at least one alkyl radical having a length of at least ten carbon atoms and at least two functional groups capable of being added to the isocyanate.

39. The method as recited in claim 38, wherein a weight of the antimicrobial agent or the biocide ranges from 2% to 15% relative to a total weight of the textile fabric.

40. The method as recited in claim 33, wherein at least one of the triisocyanate and the polyisocyanate is reacted with a substoichiometric amount of at least one of an antimicrobial agent and a biocide having a functional group capable of being added to isocyanate.

41. The method as recited in claim 40, wherein the at least one of the antimicrobial agent and the biocide includes at least one of quaternary ammonium compounds and pyridinium compounds having, as a substituent, at least one alkyl radical having a length of at least ten carbon atoms and at least two functional groups capable of being added to the isocyanate.

42. The method as recited in claim 40, wherein a weight of the antimicrobial agent or the biocide ranges from 2% to 15% relative to a total weight of the textile fabric.

43. The method as recited in claim 33, wherein the polyols include hydrophilic polyether polyols.

44. The method as recited in claim 33, wherein the reacting is performed in the presence of polar, non-ionic copolymers as a hydrophilic agent.

45. The method as recited in claim 44, wherein the hydrophilic agent includes polyether polyols based on at least one of ethylene oxide, propylene oxide, derivatives thereof and copolymers having a molecular weight ranging from 400 to 6000.

46. The method as recited in claim 45, wherein a weight of the hydrophilic agent ranges from 5% to 80% relative to the total amount of the prepolymers.

47. The method as recited in claim 33, wherein the reacting is performed in the presence of at least one of OH- or NH₂-difunctionalized and OH- or NH₂-polyfunctionalized dirt-repellant agents.

48. The method as recited in claim 47, wherein the dirt-repellant agents include fluorinated polyols having a molecular weight within the range from 500 to 6000.

49. The method as recited in claim 48, wherein the fluorinated polyols include at least one of linear perfluoropolyols and branched perfluoropolyols based on at least one of fluorinated polymethylene oxide, polyethylene oxide, polypropylene oxide, polytetramethylene oxide and copolymers thereof.

50. The method as recited in claim 47, wherein a weight of the dirt-repellant agents used ranges from 5% to 85% relative to a total weight of the prepolymers.

51. The method as recited in claim 33, wherein the polyols and diisocyanates are reacted at a molar OH:NCO ratio of 2:1 to 6:5.

52. The method as recited in claim 33, wherein the polyols are based on at least one of the following:
a polyadipate having a molecular weight ranging from 400 to 6000,
a polycaprolactone having a molecular weight ranging from 450 to 6000,
a polycarbonate having a molecular weight ranging from 450 to 3000,
copolymers consisting of polycaprolactone and polytetrahydrofuran having a molecular weight ranging from 800 to 4000,
a polytetrahydrofuran having a molecular weight ranging from 450 to 6000,
a hydrophobic polyether polyol having a molecular weight ranging from 400 to 6000,
fatty acid esters having a molecular weight ranging from 400 to 6000, and
a polysiloxane functionalized with organic terminal groups and having a molecular weight ranging from 340 to 4500.

53. The method as recited in claim 33, wherein the diisocyanates used in the reacting include at least one of aliphatic and cycloaliphatic diisocyanates such as hexamethylene diisocyanate, isophorone diisocyanate, 1,4-cyclohexane diisocyanate, 1-methyl-2,4-cyclohexane diisocyanate, 1-methyl-2,6-cyclohexane diisocyanate, 4,4′-dicyclohexyl methane diisocyanate, 2,4-dicyclohexyl methane diisocyanate, 2,2′-dicyclohexyl methane diisocyanate.

54. The method as recited in claim 33, wherein the reacting is performed at a temperature ranging from 80° C. to 140° C.

55. The method as recited in claim 33, wherein 2.5 to 15 parts by weight of the emulsifier are used relative to 100 parts by weight of the prepolymers.

56. The method as recited in claim 33, wherein the emulsifier is at least one of anionic and non-ionic.

57. The method as recited in claim 33, further comprising adding at least one polyol based on a polysiloxane functionalized with organic terminal groups to at least one of the polyols and the OH-terminated prepolymer that has been reacted out.

58. The method as recited in claim 57, wherein the polysiloxane is an OH-terminated polysiloxanes having a molecular weight ranging from 340 to 4500.

59. The method as recited in claim 33, wherein an equivalence ratio of free OH groups in the prepolymers with respect to isocyanate groups of at least one of the diisocyanate, triisocyanate and polyisocyanate is within the range from 0.8:1.2 to 1:2.

60. The method as recited in claim 33, wherein 5 to 50 parts by weight of the emulsifier are used relative to 100 parts by weight of the at least one of the diisocyanate, triisocyanate and polyisocyanate.

61. The method as recited in claim 33, wherein at least one of the reacting and the crosslinking take place without a catalyst.

62. The method as recited in claim 33, further comprising at least one of impregnating and injecting the textile fabrics with the reactive polyurethane emulsion and subsequently drying the textile fabrics.

63. The method as recited in claim 61, further comprising post-crosslinking still free OH groups of the prepolymer with the at least one of the diisocyanate, triisocyanate and polyisocyanate so as to form a crosslinked polyurethane at the same time as the drying.

64. The method as recited in claim 33, further comprising treating the textile fabrics with the reactive polyurethane emulsifier so as to provide a leather-like and a velvet-like finish.

65. A soft polyurethane having a Shore hardness A of 45 to 60, produced according to the method as recited in claim 33.

66. A textive fabric having at least one of a flame-retardant, an antimicrobial, a hydrophilic, a water-repellant and a dirt-repellant impregnation produced according to the method as recited in claim 33.
